(19) United States
(12) Patent Application Publication
(10) Pub. No.: US 2024/0238838 A1
(43) Pub. Date: Jul. 18, 2024

(54) Powder Coating Process and Facility

(71) Applicant: Akzo Nobel Coatings International B.V., Amsterdam (NL)

(72) Inventor: Michael MCCORMICK, Amsterdam (NL)

(21) Appl. No.: 18/290,067

(22) PCT Filed: May 11, 2022
(86) PCT No.: PCT/EP2022/062737

§ 371 Date: Nov. 9, 2023

(30) Foreign Application Priority Data
May 18, 2021 (EP) 21174237.4
Jun. 8, 2021 (CN) 202110639911.9

(51) Int. Cl. B05D 1/06; B05D 3/02; B05D 7/02

(52) U.S. Cl. CPC B05D 1/06; B05D 3/0254; B05D 7/02; B05D 2201/00; B05D 2401/32

(57) ABSTRACT

Process of powder coating a substrate (1) having at least one part of reduced thickness (5, 6), such as a raised edge. After application of a powder coating material, the substrate is heat cured. During heat curing, the substrate is locally shielded from the heat source (18) at the position of the part of reduced thickness, e.g., by means of a heat shield (2). The heat shield can for example be a perforated plate. Powder coating facility comprising an overhead conveyer with a plurality of jigs (3) for supporting such heat shields.

### TECHNICAL FIELD

The invention relates to a powder coating process, in particular for substrates with varying thicknesses, in particular of heat-sensitive materials. The invention also relates to a powder coating facility arranged for application of such a process.

### BACKGROUND ART

Powder coatings are typically sprayed electrostatically on a substrate. In a next step the coating is fused and cured under heat to form a finishing. Thermal set coating powders are heated to the powder's melting temperature until the coating particles fuse into a continuous film. Ultraviolet coating powders are heated in an oven and then cured by exposure to ultraviolet light.

While powder coatings were originally mainly used on metal substrates, recent developments resulted in powder coatings requiring lower curing temperatures, enabling application onto non-metal substrates, such as heat-sensitive substrates made of plastic, wood or wood based materials, in particular medium-density fiber board (MDF). Such materials are for example used for domestic furniture and kitchen cabinets. Besides being made of a more heat sensitive material, such objects can also have a more complex geometry with a varying thickness, e.g., to form integrated handles, grips or the like.

Before applying powder coating material onto an MDF substrate, the MDF can optionally be preheated to a temperature in the range between about 65 and 120° C. to make the substrate electrically conductive. The substrate is then moved through a spray booth, where negatively charged powder is sprayed onto the grounded MDF substrate. In a next step, the substrate is moved to a heat curing station to heat cure the applied powder layer, for example in a convection oven or by infrared heat.

Overheating of non-metal or metal substrates can result in a variety of surface defects. Heat curing of a powder coated MDF substrate, for example, results in expansion of entrapped air. Degassing of the MDF during curing results in formation of pinholes and other surface defects. Other defects caused by overheating are for example gloss variation, yellowing and a decline in mechanical properties, in particular strength and stiffness, which results in warping and cracks in the substrate.

Local overheating can especially occur with substrates having one or more parts of reduced thickness, such as panels with a profiled edge. A varying thickness of the substrate results in an uneven heat distribution, particularly with substrate materials having relatively low heat conductivity, such as non-metals. Curing typically takes place at 85-140° C. or higher in particular circumstances. In case of substrates with a varying thickness, thin-walled parts can show temperature peaks of about 40° C. or more compared to the thicker material sections. Moreover, raised edges of the substrate may hide adjacent parts from the heat source. To cure such hidden parts higher curing temperatures should be used, which can result in overheating of other parts.

The article “Pinhole Free Smoother Finishing on MDF”, H. Renkema et al., European Coatings Journal, March 2017, discloses so-called asynchronous heat curing of powder coated MDF substrates. With this process, different sides of the substrate are cured sequentially, rather than simultaneously, allowing gas to escape at the side that is cured latest. One of the ways to achieve this is to use a heat shield shielding one side of the substrate to delay curing. In a next step, the heat curing process is interrupted in order to remove the heat shield so as to allow the uncured side to cure. This process does not prevent local overheating of profiled edges or similarly varying substrate thicknesses.

### SUMMARY OF INVENTION

It is an object of the invention to provide effective protection against local overheating during heat curing of a powder coated substrate having one or more parts of reduced thickness.

The object of the invention is achieved with a process of powder coating a substrate with at least one part of reduced thickness. During heat curing at least one side of the substrate is locally shielded from the heat source at the position of the part of reduced thickness. While the thinner part is shielded, thicker parts are still directly exposed to the heat source. It was found that local heat shielding of thinner parts of the substrate significantly reduces temperature variations between thicker and thinner substrate parts and avoids local overheating without slowing down the curing process. Avoiding temperature peaks makes it possible to increase the overall curing temperature in order to improve curing of substrate parts that are hidden from the heat source.

### DESCRIPTION OF EMBODIMENTS

To shield the substrate a heat shield can be used. The heat shield can be customized to adjust the degree of thermal shielding. For example, perforated heat shields can be used, in particular heat shields having an array of openings allowing passage of air and heat, or heat shields having other geometrically customized heat transfer passage. The degree of heat transfer passage can be defined by the number and the diameter of the openings, or it can be defined by any other suitable geometrical features, such as non-circular openings or open slots or the like, or the heat shield can comprise a series of parallel slats or blinds or the like.

In a refinement, the heat shield is selected from a plurality of heat shields providing different degrees of heat shielding, e.g., having a different number of openings and/or openings of different sizes. Depending on the local substrate geometry and the heat conductive properties of the substrate material, a suitable heat shield can be selected providing effective and customized shielding with minimized processing delay.

The heat shield can be placed after the substrate leaves the spray booth and before it enters a heat curing station. The heat shield is typically not in contact with the susbtrate. Instead it is typically situated at a distance from the substrate to avoid affecting the applied powder coating layer.

A typical lay-out for a powder coating facility comprises a conveyer system transporting the substrates successively through a spraying booth and a heat curing station. Optionally, the conveyer system first transports the substrates through a pre-heating station. Such a conveyer system typically comprises a transport rail and jigs moveable along the transport rail. The jigs are used to suspend the substrates, usually boards or panels suspended in a substantially vertical position. An example of such a system is disclosed in U.S. Pat. No. 9,162,245. The line speed of the system is adjusted to provide a sufficiently long residence time of the substrate in the successive stations.

The substrate can for example be suspended from an overhead conveyor by means of a jig comprising substrate supports, usually hooks, for carrying the substrate, and shield supports for carrying the heat shield at a distance from the substrate. The substrate is hooked to the substrate supports of the jig before it enters the spray booth. When the jig carrying the substrate leaves the spray booth, the heat shield is attached to the heat shield supports of the jig. The jig with the substrate and the heat shield is then moved into the heat curing station. After the jig leaves the heat curing station, the heat shield is removed from the jig and, in a next step, the powder coated substrate is removed from the jig.

The heat shield can be made of any suitable material, e.g., materials having low specific thermal capacity, e.g., below 2 J/(g·° C.). Particularly suitable are heat shields of wood or medium-density fiber board (MDF). This allows fast and easy handling and removal of the heat shields after they leave the heat curing station.

The process can be used for any type of substrate to be powder coated, in particular for substrates with a risk of local overheating, e.g., due to the type of substrate material and/or local thickness variations. The process is particularly suitable for non-metal substrates, such as heat-sensitive substrates made of plastic, wood or wood based materials, in particular medium-density fiber board (MDF). The substrate parts of reduced thickness can for example be raised edges or profiles, e.g., forming integrated handles or grips or other functionalities.

The substrate to which a powder coating material is applied in the process can optionally already comprise one or more coating layers, for example a primer layer, which can be either cured, uncured or partially cured. In such embodiments, the substrate itself (absent any coating layers) has one or more parts of reduced thickness. Typically, the substrate and any optional pre-coated layers also have one or more parts of reduced thickness.

The process of the present disclosure can be carried out with any type of powder coating, e.g., thermosets, thermoplastics, or UV curable powder coatings. The powder coating can be based on any suitable polymer binder, including but not limited to, polyesters, polyurethanes, polyester-epoxy, straight epoxy (fusion bonded epoxy), acrylics or hybrids or mixtures thereof.

The process can be carried out in a powder coating facility comprising a heat curing station, e.g., a convection cure oven or an infrared cure oven, such as a gas catalytic infrared oven.

The powder coating facility may further comprise an overhead conveyer with a plurality of jigs, as disclosed above, and a plurality of heat shields attachable to the jigs. To this end, the jigs may comprise heat shield supports for holding one of the heat shields at a distance from the substrate. The heat shield supports of the jigs comprise a hook for engaging an opening in the heat shield, and a spacer below the hook for maintaining the heat shield in a substantially vertical position. The jig may for example comprise two identical rods with hook-shaped lower ends for engaging matching openings in a substrate. Such rods will typically hang down from a rail conveyer and be moveable along the rail in a conventional manner. Using such jigs, the heat shield supports can for example be C-shaped brackets with a middle section attached to the respective rod, a hook-shaped top section and a lower section substantially parallel to the top section forming the spacer for maintaining the heat shield in a substantially vertical position.

### DESCRIPTION OF DRAWINGS

The invention will further be explained with reference to the accompanying drawings, showing an exemplary embodiment.

FIG. 1: shows in perspective view an arrangement of a heat shield and a substrate according to a process of the present invention;

FIG. 2: shows the arrangement of FIG. 1 in front view;

FIG. 3: shows the arrangement of FIG. 1 in side view;

FIG. 4: shows the arrangement of FIG. 1 in rear view.

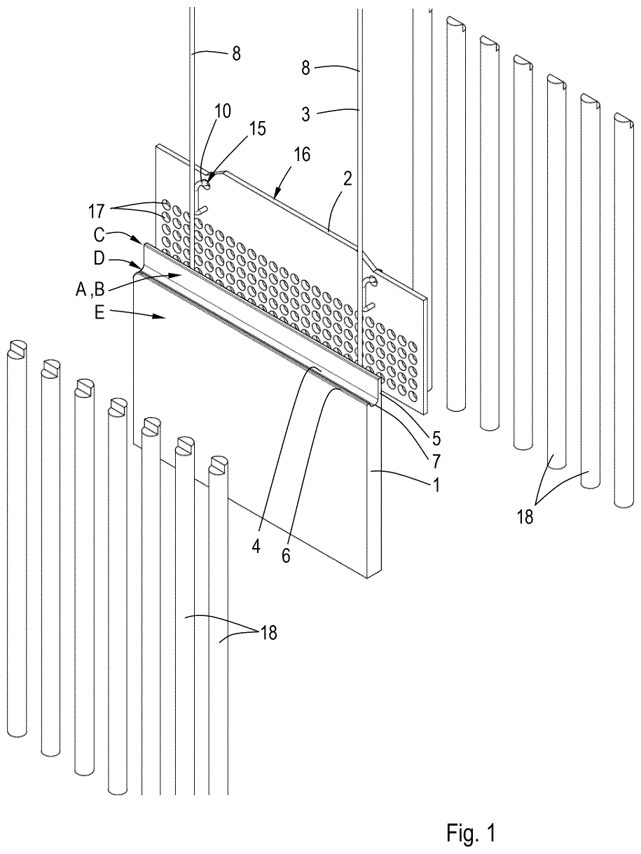

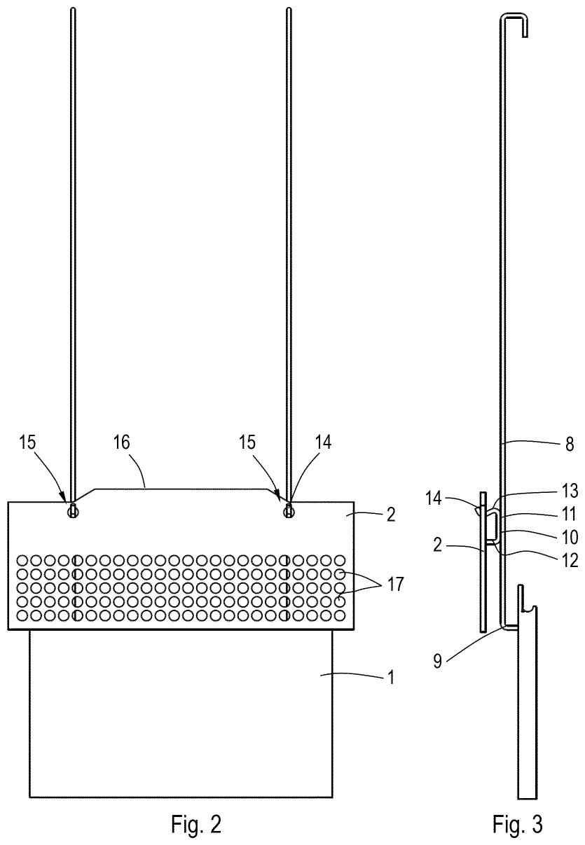

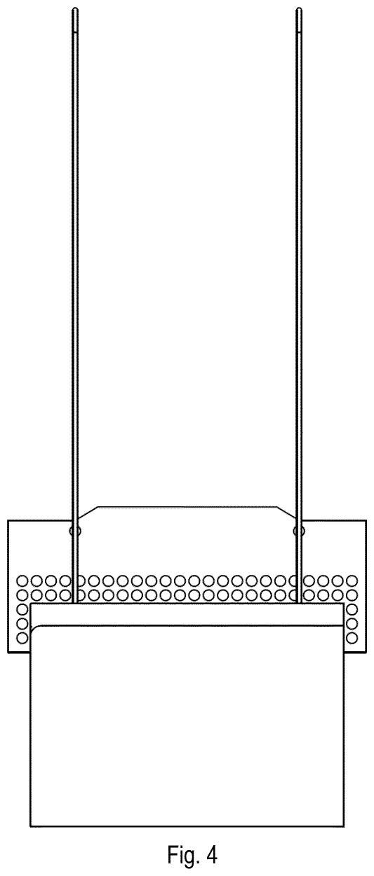

FIGS. 1-4 show an arrangement of a substrate 1 shielded by a heat shield 2 both supported by a jig 3. The substrate 1 is a rectangular MDF panel, designed as a kitchen cabinet door, with one profiled edge 4 having a more complex geometry with a varying thickness. This substrate 1 is shown in the drawings merely by way of example.

The profiled edge 4 has a J-shaped cross section with portions of reduced thickness, namely a higher raised edge 5 at a rear side of the substrate 1 and a lower raised edge 6 at a front side of the panel, with a recess 7 between the higher raised edge 5 and the lower raised edge 6. The recess 7 is dimensioned to form a grip or handle for a user's fingers.

The jig 3 comprises two identical vertical rods 8 of even length with hook-shaped lower ends 9 (FIG. 3) engaging matching blind openings (not shown) in the rear side of the substrate 1. The jig 3 is suspended from an overhead rail conveyer (not shown) to move the substrate 1 through a spray booth and subsequently through a heat curing station. Jigs comprising a pair of parallel steel rods with hook-shaped lower ends are commonly used in the field of powder coatings application.

The jigs 3 shown in the drawings differ with the usual jigs in that the two rods 8 are both identically provided with a C-shaped bracket 10 with a middle section 11 attached to the respective rod 8, a lower section 12 pointing away from the rod, and an upper section 13. The lower section 12 points in a heat shield direction, which is opposite to the pointing direction of the hook-shaped ends 9 of the rods 3. The upper section 13 of the C-shaped bracket 10 also points in the heat shield direction, but is downwardly inclined and comprises an upwardly bent tip 14 forming a hook. These C-shaped brackets 10 serve to hang and position the heat shield 2. The C-shaped brackets 10 are of the same size and at the same distance from the hook-shaped ends 9 of the rods 3.

The heat shield 2 is also shaped as a panel and has two through-openings 15 symmetrically arranged near a top edge 16 of the heat shield 2. The distance between the two through-openings 15 is the same as the distance between the blind openings in the substrate 1 receiving the hook shaped ends 9 of the jig 3. The heat shield 2 is provided with an array of circular openings 17 defining a customized heat transfer passage. Different heat shields 2 can have a different heat transfer passage, allowing to select a customized heat shield for a particular substrate. The heat transfer passage can be defined by the number and the diameter of the openings 17, or they can be defined by other suitable geometrical features, such as non-circular openings or open slots or the like.

Before entry into the spray booth, the substrate 1 can be hung on the hooks-shaped ends 9 of the jig 3. The jig 3 is then transported into the spray booth where the substrate 1 is powder coated. In a next step the jigs 3 move the substrate 1 outside the spray booth.

Here, the heat shield 2 is hung on the upper ends 13 of the C-shaped brackets 10 of the jig 3. The lower ends 12 of the C-shaped brackets 10 space the heat shield 2 from the jig 3 and maintain the heat shield 2 in an essentially vertical position. To this end, the lower ends 12 of the C-shaped brackets 10 are of the same length as the downwardly inclined section of the upper parts 13 of the C-shaped brackets 10. The jig 3 is then moved into the heat curing station. Here, the heat shield 2 is between the profiled edge 4 of the substrate 1 and a heat source 18 of the heat curing station (see FIG. 1). As a result, temperature peaks in the thinner raised edges 5, 6 of the substrate 1 are effectively avoided or at least substantially reduced, as will be shown with the measurement data of the Example below.

### EXAMPLE

An MDF panel as shown in the Figures was powder coated and cured in an electric IR/convention air oven at 150° C. with a line speed of 0.8 m/min. The MDF panel had a thickness of 22 mm except at the position of the profiled edge 4. During the curing process, the temperature was measured at the positions A-E as shown in FIG. 1: Position A was at the front side of the higher raised edge 5 (thickness 5.8 mm), position B was at the same position as position A but at the back side of the higher raised edge 5 (thickness 5.8 mm), position C was at the top edge of higher raised edge 5 (thickness 5.8 mm), position D was in the recess 7 between the higher raised edge 5 and the lower raised edge 6 of the profiled edge 4 (thickness 22 mm) and position E was at the front side of the panel (thickness 22 mm).

In a first run, no heat shield was used. In a second run, a heat shield as shown in the drawings was used with an array of openings 17 having a diameter of 12 mm with a center-to-center distance of 16 mm. The heat shield was made of MDF and had a thickness of 6 mm.

The heat shield 2 was supported by a jig 3 at a distance of 38 mm in front of the substrate. The heat shield 2 overlapped the upper 55 mm of the substrate 1 over its full width. The substrate had a total height of 250 mm. The heat shield 2 shielded positions A, B, C and D. Position E was not shielded.

In a third run, a heat shield 2 was used in the same position with an array of openings having a diameter of 10 mm. In a fourth run, a heat shield was used with an array of openings having a diameter of 6 mm. The measured temperatures are shown in Table 1.

TABLE 1
Temperatures in ° C.

| Position | A | B | C | D | E |
|---|---|---|---|---|---|
| Run 1 | 167.1 | 172.9 | 190.4 | 140.3 | 149.2 |
| Run 2 | 159.8 | 147.1 | 166.3 | 136.8 | 149.9 |
| Run 3 | 161.8 | 145.4 | 166.1 | 140 | 152.9 |
| Run 4 | 160.9 | 141.4 | 163.2 | 139.9 | 152.9 |

As shown in Table 1, the temperature gradient in Run 1 (no shield) was about 50° C. This was reduced to a temperature gradient of about 23° C. in Run 4. Particularly at position C, the temperature peak was smoothed out by about 27° C. The temperature remained constant at the inside of the profiled edge 4.

Avoiding temperature peaks on positions A, B and C makes it possible to increase the overall curing temperature in order to improve curing of substrate parts that are hidden from the heat source by the raised edges, such as position D.

1. A process of powder coating a substrate, the substrate having at least one part of reduced thickness, wherein after application of a powder coating material on the substrate, the substrate is heat cured in a heat curing station comprising a heat source, wherein during heat curing the substrate is locally shielded from the heat source at the position of the part of reduced thickness.

2. The process according to claim 1, wherein the heat shield is not in contact with the substrate.

3. The process according to claim 1, wherein the part of reduced thickness of the substrate is shielded using a heat shield with an array of openings.

4. The process according to claim 3, further comprising the step of selecting the heat shield from a plurality of heat shields having openings of different sizes.

5. The process according to claim 1, wherein the substrate and the heat shield are jointly moved by a conveyer along a spraying station and subsequently a curing station comprising an oven.

6. The process according to claim 5, wherein the substrate is suspended from a jig movable by the conveyer, the jig comprising substrate supports for carrying the substrate and shield supports for carrying the heat shield at a distance from the substrate.

7. The process according to claim 6, wherein the shield supports hold the heat shield essentially parallel to the substrate.

8. The process according to claim 1, wherein the substrate is a panel and wherein the shielded part of reduced thickness is a profiled edge.

9. The process according to claim 1, wherein the substrate is made of non-metal material.

10. The process according to claim 1, wherein the heat shield is a panel made of non-metal material.

11. A powder coating facility comprising an overhead conveyer with a plurality of jigs and a plurality of heat shields;
wherein at least one of the jigs comprises heat shield supports for holding one of the heat shields at a distance from the substrate.

12. The powder coating facility according to claim 11, wherein the plurality of heat shields include a set of heat shields having different heat transfer passages.

13. The powder coating facility according to claim 12, wherein the heat shields include perforated plates with openings, and wherein the heat transfer passage is defined by the size and number of the openings varying per heat shield.

14. The powder coating facility according to claim 11, wherein the heat shield supports of the jigs comprise a hook for engaging an opening in the heat shield, and a spacer below the hook for maintaining the heat shield in a substantially vertical position.

15. The process according to claim 9, wherein the non-metal material is a heat sensitive material.

16. The process according to claim 15, wherein the heat sensitive material is plastic, wood, or a wood based product.

17. The process according to claim 16, wherein the wood based product is medium-density fiber board (MDF).

18. The process according to claim 10, wherein the non-metal material is a material having a heat capacity below 2 J/(g·° C.).

19. The process according to claim 18, wherein the material having a heat capacity below 2 J/(g·° C.) is plastic, wood, or a wood based product.

20. The process according to claim 19, wherein the wood based product is medium-density fiber board (MDF).
